(19) United States
(12) Patent Application Publication
(10) Pub. No.: US 2026/0053081 A1
(43) Pub. Date: Feb. 26, 2026

(54) System

(71) Applicant: Softbank Group Corp., Tokyo (JP)

(72) Inventor: Mikihiko Takahashi, Tokyo (JP)

(21) Appl. No.: 19/301,414

(22) Filed: Aug. 15, 2025

(30) Foreign Application Priority Data
Aug. 20, 2024 (JP) 2024-138727

(51) Int. Cl. A01B 76/00; G05B 13/02

(52) U.S. Cl. CPC A01B 76/00; G05B 13/027

(57) ABSTRACT

A system includes a processor that collects environmental data using a sensor, transmits the environmental data to a server, analyzes the environmental data using a generative AI, automatically controls agricultural equipment based on the data analysis, and notifies a user of the analysis results and control information.

### CROSS-REFERENCE TO RELATED APPLICATION

This application is based on and claims priority under 35 USC 119 from Japanese Patent Application No. 2024-138727 filed on Aug. 20, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, the automation and optimization of agricultural operations have become increasingly important to address issues such as labor shortages, inefficiency, and the need for precise management of crop environments. Conventional systems often lack the ability to intelligently analyze environmental data and adjust agricultural equipment operations automatically in response to changing conditions. Furthermore, many existing solutions do not provide real-time feedback to users, nor do they allow for easy customization or instruction by the user. Accordingly, there is a need for a system that enables comprehensive automation and intelligent control of agricultural processes through real-time data analysis and user interaction.

### SUMMARY

The present invention provides a system including a processor that collects environmental data using sensors, transmits the environmental data to a server, analyzes the data by means of a generative AI, and automatically controls agricultural equipment based on the analysis results. The system further notifies the user regarding the analysis outcomes and control information. Additionally, the invention enables the generative AI to include algorithms for predicting optimal plant growth conditions, and provides an interface allowing the user to change settings or issue additional instructions, thereby achieving both automation and user-driven customization in agricultural management.

“Sensor” means a device or component configured to detect, measure, and collect specific environmental parameters, such as temperature, humidity, or soil moisture, within an agricultural setting.

“Environmental data” means information obtained from sensors representing the physical or chemical conditions of the agricultural environment, including but not limited to temperature, humidity, soil moisture, and other relevant metrics.

“Server” means a computing device or system designed to receive, store, and process environmental data transmitted from terminals or sensors, and to manage data analysis and communication functions within the system.

“Generative AI” means an artificial intelligence system capable of analyzing environmental data, learning from historical information, and generating predictive or prescriptive outputs to optimize agricultural management.

“Processor” means a central processing component, such as a microprocessor or microcontroller, configured to execute instructions for data collection, communication, analysis initiation, equipment control, and user interface management.

“Agricultural equipment” means devices or machinery used in the management, maintenance, or cultivation of agricultural fields, such as irrigation systems, fertilizer dispensers, or other automated farming tools.

“Data analysis” means the process of examining, processing, and interpreting environmental data using computational algorithms, including those implemented by generative AI, to derive actionable insights.

“Control instruction” means a command or signal generated based on the results of data analysis, which directs agricultural equipment to perform specific operations automatically.

“User” means an individual or entity who interacts with the system, receives notifications, monitors system status, and is capable of providing instructions or customization to the agricultural management process.

“Interface” means a software or hardware component that enables communication between the user and the system, allowing the user to receive information, monitor processes, and provide inputs, such as setting changes or additional instructions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

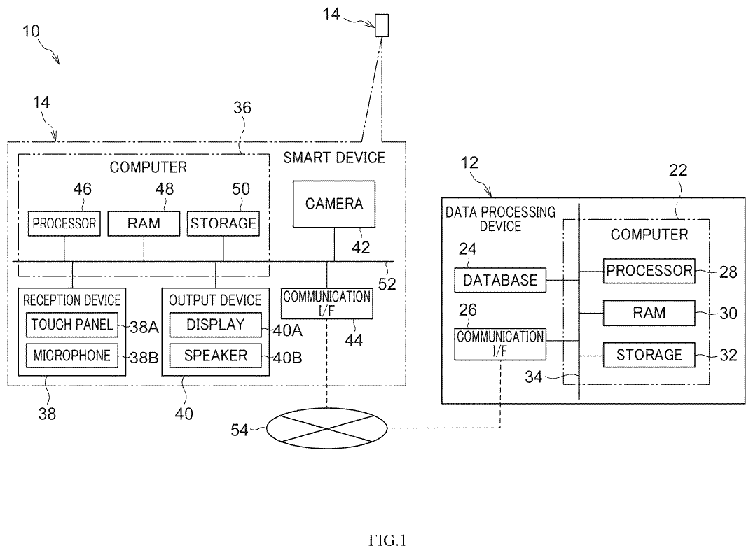

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

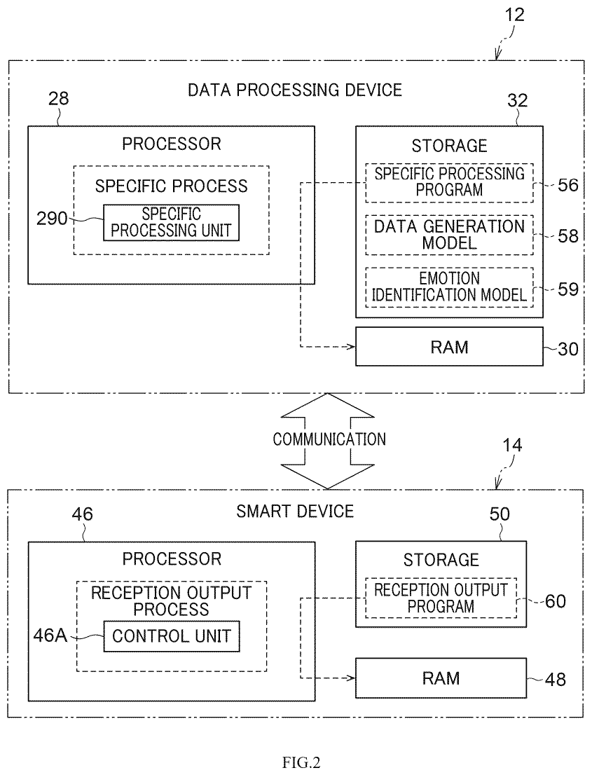

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional agriculture management systems, efficient collection, analysis, and utilization of environmental data are difficult to achieve. Existing systems often require manual intervention for both data collection and operational control of agricultural machinery, resulting in increased labor and delayed response to environmental changes. Furthermore, even when artificial intelligence is introduced, input preparation and prompt engineering for AI models may lack automation, thereby limiting the accuracy and timeliness of decision-making. There is a need for a system that not only automates the acquisition and processing of environmental data using generative artificial intelligence models, but also enables dynamic generation of AI input sentences and responsive, automated operation of agricultural machinery with seamless user intervention.

The specific processing by the specific processing unit 290 of the data processing device 12 in Example 1 is realized by the following means.

The present invention provides a server including a processor configured to acquire environmental state information from an information acquisition device, analyze the information with a generative artificial intelligence model while dynamically generating an input sentence for the model, generate and output control instructions for a work machinery control device based on analysis results, and notify a user terminal of the results and control information, as well as update settings based on user input. This enables fully automated, accurate, and responsive agricultural environment management, including the active use and optimization of generative AI models and real-time interaction with users through a dedicated interface.

The term “information acquisition device” refers to a generic apparatus configured to obtain environmental state information, such as sensors for temperature, humidity, or other relevant physical parameters.

The term “environmental state information” refers to data representing real-world physical or chemical conditions in an agricultural or natural environment, including but not limited to temperature, humidity, and soil moisture levels.

The term “terminal device” refers to a computing unit, such as a microcontroller or embedded system, that temporarily stores environmental state information from an information acquisition device and communicates this information to a server.

The term “information processing device” refers to a computing system, such as a server, equipped to perform data storage, analysis, generation of control instructions, and communication tasks.

The term “information storage apparatus” refers to a storage device or memory component used for systematically recording, retaining, and managing environmental state information within the system.

The term “generative artificial intelligence model” refers to an artificial intelligence algorithm or framework, such as a deep learning network, designed to analyze data and generate predictive outputs, control instructions, and dynamically constructed input sentences for enhanced performance.

The term “input sentence” refers to a structured textual or data-based prompt that is provided to the generative artificial intelligence model to guide or optimize its analysis. The term “analysis process” refers to a computational procedure performed by the information processing device wherein the generative artificial intelligence model processes the environmental state information to extract insights or predictive outcomes.

The term “work machinery control device” refers to an apparatus that receives control instructions and activates or deactivates agricultural equipment, including but not limited to irrigation or fertilizing machinery.

The term “control instructions” refers to actionable commands generated by the system to direct the operation of the work machinery control device.

The term “user terminal” refers to a computing or display device, such as a smartphone or computer, through which a user receives notifications and is able to interact with the system.

The term “user input” refers to any manual configuration, operational command, or setting adjustment provided by the user through a dedicated interface.

The term “dedicated operation interface” refers to a specialized software or hardware interface, such as an application or web portal, designed to facilitate user interaction with the system for control, setting updates, or status monitoring.

One embodiment for practicing the invention is described below, based on the claims.

The system can be constructed using a combination of information acquisition devices such as temperature sensors, humidity sensors, and soil moisture sensors—which may include devices like DHT22 and YL-69—installed in an agricultural field. These sensors are connected to a terminal device, such as a microcontroller or single-board computer, for example, a general-purpose board like Raspberry Pi or Arduino.

The terminal device is configured with embedded software capable of reading environmental state information from the sensors at regular intervals. The measured data, including temperature, humidity, and soil moisture, are temporarily stored using a lightweight database such as SQLite in the terminal device.

At predetermined intervals, the terminal device converts the stored environmental data into a structured data format, such as CSV, and transmits it to an information processing device, which is typically realized as a general-purpose server computer. The data transmission can be performed using standard communication protocols, such as HTTP POST requests or MQTT.

The information processing device (server) is implemented on a hardware platform such as a virtual server or general-purpose computing server, and may utilize commercial cloud computing resources. The server runs application software to receive data sent from the terminal device and then stores such data in an information storage apparatus such as a database server, for example, using a relational database such as MySQL or PostgreSQL. The server is further configured to perform an analysis process utilizing a generative artificial intelligence model, implemented through machine learning frameworks such as PyTorch or TensorFlow. The server loads current and historical environmental data from the database and prepares a prompt sentence that describes the desired analysis or prediction. An example of the prompt sentence is:

“Analyze the last seven days'temperature and humidity data and recommend the best irrigation time today.”

By dynamically generating a prompt sentence that reflects the need of the analysis, the server improves the performance and accuracy of the generative AI model.

The server feeds the prompt sentence and environmental data into the generative AI model for processing. The AI model generates results—such as recommendations or control instructions—for the operation of agricultural machinery.

For instance, the AI model may produce a result as follows:

“It is recommended to start irrigation at 14:00 due to high expected temperature.”

Based on the AI model's analysis, the server generates a control instruction to operate the selected agricultural equipment, such as irrigation or fertilization devices. The control instruction is sent back to the terminal device in a structured format using a standard communication channel.

The terminal device receives the control instruction and activates the appropriate machinery at the designated time—such as triggering a relay to start irrigation. The terminal device logs the activation and can send feedback to the server as necessary.

The server is also responsible for notifying users regarding analysis results and actions taken. This is achieved by pushing notifications to a user terminal, such as a smartphone or personal computer, through platforms like web portals or push notification services (for example, Firebase Cloud Messaging). The user reviews the notifications via a dedicated operation interface, such as a mobile application or a web-based control panel implemented with web frameworks like React.js or Angular. The user can further input new configuration settings or instructions, which are transmitted to the server for immediate update of control policies.

As a concrete example, a user may receive the following notification:

“Irrigation was started at 14:00 today based on AI analysis.”

Users can also interact with the system by submitting additional settings or control changes, for example:

“Set the lower threshold of soil moisture to 45%.”

Through this architecture, the entire cycle of environmental data measurement, adaptive AI-driven analysis, prompt generation, automatic machinery control, user interaction, and feedback is realized in a seamless, efficient, and automated manner. This enables highly accurate and responsive agricultural environment management according to the technical scope defined in the claims.

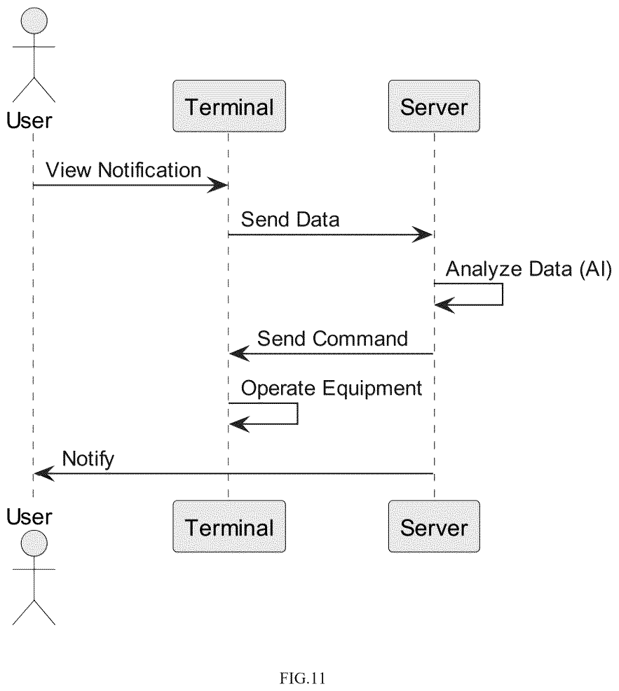

The following describes the processing flow using FIG. 11.

### Step 1

The terminal collects environmental state information, such as temperature, humidity, and soil moisture, from sensors deployed in the field. As input, the terminal receives real-time analog or digital signals from multiple types of sensors (for example, temperature and soil moisture sensors). The terminal processes these signals by sampling, converting them into digital data, and then storing the measured values in a local database such as SQLite. The output is a set of structured environmental data entries, each associated with a timestamp and sensor source.

### Step 2

The terminal temporarily stores the collected environmental data within its local database. As input, the terminal uses the digitized sensor data acquired from the sensors. The terminal processes this data by formatting it into a structured table and marking it as new or pending for upload. The output is a set of environmental data records, organized and ready for subsequent data transmission.

### Step 3

The terminal transmits the temporarily stored environmental data to the server at predetermined intervals. The input for this step is the set of data records stored and marked for upload. The terminal processes these records by formatting them, for example, into CSV files, and initiates data transfer using a communication protocol such as HTTP POST. The output is the transmission of environmental data packets to the server.

### Step 4

The server receives the environmental data transmitted by the terminal and stores it within a database system. As input, the server receives environmental data formatted in a standard structure (such as CSV or JSON). The server parses the incoming data stream, validates the records for correctness and completeness, and then stores the validated records in a relational database such as MySQL or PostgreSQL. The output is an organized dataset of environmental state information stored in the server's database.

### Step 5

The server performs an analysis of the stored environmental data using a generative AI model. As input, the server retrieves the relevant environmental data, often including both current and historical data entries, from its database. The server prepares a prompt sentence based on the intended analysis, such as “Analyze the last seven days'temperature and humidity data and recommend the best irrigation time today,” and provides this prompt together with the data to the generative AI model implemented using machine learning frameworks. The server processes the data and prompt through the AI model, which executes predictive computations and generates optimal recommendations. The output is an analysis result containing actionable insights or control recommendations.

### Step 6

The server generates control instructions based on the analysis results output by the generative AI model. As input, the server uses the result from the previous step, which may recommend specific actions or time schedules for controlling agricultural machinery. The server processes this input by encoding the actionable instructions into a structured format, such as a JSON object, specifying the type of equipment, the operation to be performed, and the execution time. The output is a JSON control instruction message sent to the terminal.

### Step 7

The terminal receives the control instruction from the server and activates the appropriate agricultural equipment according to the instruction. As input, the terminal receives the JSON message indicating specific actions—such as “start irrigation at 14:00.” The terminal processes this instruction by scheduling the time and activating the corresponding relay circuit at the specified moment to control the equipment. The output is the physical actuation of the agricultural machinery and a log entry recording the operation.

### Step 8

The server creates a notification containing the analysis results and control actions performed and sends this notification to the user's terminal device. As input, the server uses both the analysis output and a record of the machinery control events. The server processes this information to generate a user-friendly notification message, which is transmitted using notification services like push messaging. The output is a notification displayed on the user terminal, such as a smartphone or computer interface.

### Step 9

The user reviews the received notifications and, if desired, sends new configuration instructions or changes system parameters via a dedicated operation interface. As input, the user reads the notification on the interface and may provide new setting values, such as threshold adjustments or alternate schedules. The terminal or server processes the user input by applying configuration updates or generating new control instructions for the next cycles. The output is an updated system setting or newly scheduled command stored in the server's configuration database and reflected in subsequent operations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In recent years, there has been a growing need for automation and efficiency in various operational environments, such as agriculture, logistics, and quality management. Conventional systems are limited in their ability to comprehensively collect and analyze environmental and operational data, to autonomously control equipment in response to changing conditions, to optimize delivery routes in real time, and to respond flexibly to user input and emotional state. Furthermore, these systems often lack integration between data-driven decision making, user feedback processing, and adaptive notification based on emotional recognition, resulting in reduced efficiency, user satisfaction, and operational quality.

The specific processing by the specific processing unit 290 of the data processing device 12 in Application Example 1 is realized by the following means.

The present invention provides a server including a processor configured to obtain state information via an information acquisition device, analyze the state information and historical records using a generative artificial intelligence model, automatically control operational devices based on analytical results, notify users via an interactive interface, optimize route selection and delivery operations, accept and analyze user input and feedback, and adjust notifications and support according to the user's emotional state. This enables comprehensive, automated, and adaptive management of environmental and operational conditions, improves user responsiveness and satisfaction, and significantly enhances overall system efficiency and quality.

The term “processor” refers to a data processing unit or computing device configured to execute programmed instructions for controlling, analyzing, and managing system operations.

The term “information acquisition device” refers to a hardware component or system, such as sensors or data collection modules, capable of obtaining state information from the environment or equipment.

The term “state information” refers to any data representing the current condition or parameters of an environment, object, or equipment, including but not limited to temperature, humidity, position, or operational status.

The term “information processing device” refers to a computing apparatus or server for receiving, storing, and processing state information as well as managing communication with other system components.

The term “historical records” refers to archived datasets or previously collected state information stored for reference and analysis over time.

The term “generative artificial intelligence model” refers to an artificial intelligence algorithm or system trained to generate predictions, recommendations, or analyses based on input data and past records.

The term “operation device” refers to any controlled system or apparatus, such as machinery, actuators, or automated equipment, that executes actions or adjustments in response to control instructions.

The term “interactive display device” refers to a user interface apparatus, such as a touchscreen, computer monitor, or mobile terminal, capable of outputting information and accepting user inputs.

The term “user” refers to any operator, individual, or entity interacting with the system via a user interface for monitoring, control, or feedback purposes.

The term “operation input” refers to commands, instructions, or adjustments provided by the user through the interactive display device to influence or reconfigure system behavior.

The term “opinion information” refers to feedback, assessments, or subjective input submitted by the user regarding the system's operation, performance, or output.

The term “multiple moving objects” refers to two or more mobile entities, such as vehicles, robots, or delivery machines, whose locations and statuses are monitored and managed by the system.

The term “environmental status” refers to conditions or parameters in the surroundings of an object or system, including temperature, humidity, or external factors impacting operation.

The term “route selection instruction” refers to system-generated guidance or commands that recommend or specify optimal paths or sequences for movement by a moving object.

The term “emotional state” refers to the psychological or affective condition of the user, such as stress, satisfaction, or anxiety, as recognized by the system.

The term “emotion estimation engine” refers to a computational module or software that determines the emotional state of the user by analyzing input signals, such as voice, facial expressions, or text.

One embodiment for implementing the invention will now be described. The system is structured from a server, one or more terminals, various information acquisition devices (such as sensors), operational devices (such as machinery or actuators), an interactive display device, and an emotion estimation engine. The following description outlines the configuration and operational principles required to realize the claimed invention.

The terminal collects state information using information acquisition devices. Typical sensors include temperature sensors, humidity sensors, soil moisture sensors, as well as position or status sensors mounted on moving objects such as vehicles or robots. The terminal may comprise a personal computer, smartphone, tablet, or embedded microcontroller platform. For example, a Raspberry Pi or an equivalent data acquisition system may be equipped with DHT22 temperature/humidity sensors and soil moisture sensors.

The terminal processes raw sensor data, formats it with timestamps, and temporarily stores it in local memory or an internal database, such as SQLite.

The terminal periodically transmits the acquired data to the server using a secure network connection (e.g., through https protocol using Python and requests library). The server consists of one or more computers, such as cloud servers or on-premises servers, running an operating system (such as Linux or Windows), and application logic implemented in a language such as Python with the Flask framework.

Upon receiving the state information, the server stores the records in a central database, such as PostgreSQL or MySQL, for subsequent use and historical analysis.

The server analyzes both real-time and stored historical state information by means of a generative artificial intelligence model, for example, a large language model such as GPT-4 or a fine-tuned local AI model. The server generates and sends prompt sentences containing environmental data, operational context, or user-provided information to the generative AI model. Based on the output, the server determines control strategies and operational commands for various equipment such as irrigation pumps, fertilizer dispensers, or vehicle routing systems.

In addition, the server generates user notifications based on the AI results and operational status. These notifications are delivered to the user through an interactive display device, which may be implemented as a web portal, mobile application, or a touchscreen display.

The user can interact with the system by reviewing status updates, altering configuration settings, or providing feedback and opinion information through the user interface. For example, the user may modify irrigation schedules, halt certain operations, or rate the quality of deliveries. The server collects and processes such user inputs, converts them into prompt sentences, and analyzes them with the generative artificial intelligence model to reflect appropriate changes in device control or information presentation.

For delivery or logistics applications, the server can receive state information (such as location, traffic status, or environmental conditions within a delivery vehicle) and automatically select optimized routes using routing algorithms and real-time analysis by the generative AI model.

Furthermore, the server is equipped with an emotion estimation engine. This module analyzes emotional cues in user input, such as voice data, text, or facial expressions captured via the interactive display device. If the emotion estimation engine detects stress, anxiety, or dissatisfaction, the server modifies notification content—for example, using a more sensitive tone or providing additional guidance.

Examples of prompt sentences generated and used within the system include:

“Analyze temperature: 25° C., humidity: 60%, soil moisture: 40%. Predict the optimal watering time for best crop growth.”

“Generate an optimal delivery route from point A to point B, considering current traffic and priority orders.”

“Based on user feedback: ‘Delivery was late and the food was cold,’ analyze the root cause and suggest improvements.”

“Recognize and classify the user's emotion based on this audio/text input: [user input].”

By utilizing these hardware and software components, including sensors, terminal devices, a server with generative artificial intelligence capabilities, an interactive display device, and an emotion estimation engine, the system enables comprehensive environmental data collection, advanced data-driven analysis, responsive machine control, adaptive user interaction, and intelligent logistics management. This approach supports automation and quality improvement in multiple fields, such as agriculture, logistics, and facility operations.

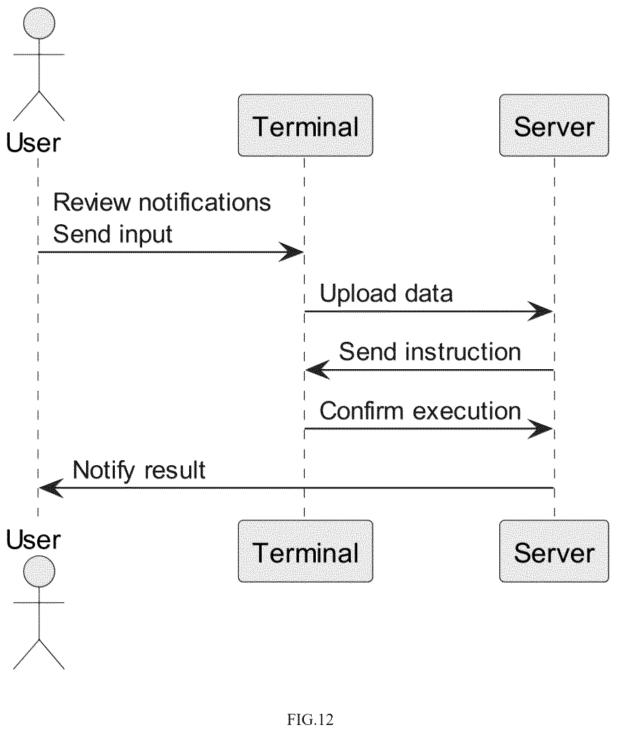

The following describes the processing flow using FIG. 12.

### Step 1

The terminal activates various information acquisition devices, such as temperature sensors, humidity sensors, and soil moisture sensors, to collect state information at predefined intervals. The input for this step is the environmental and operational conditions from the surrounding area or equipment. The terminal formats the raw sensor data with corresponding timestamps, processes the data to check the validity and range, and stores it temporarily in local memory or a lightweight database. The output is a locally stored, time-stamped dataset containing verified sensor measurements.

### Step 2

The terminal aggregates the time-stamped sensor data and determines whether the upload condition has been met (for example, when a certain amount of data has accumulated or a specific time has elapsed). The input for this step is the local dataset containing validated sensor readings. The terminal then establishes a secure connection to the server using network communication protocols and uploads the batched data in structured format (such as JSON) via an API. The output is the successful transmission of sensor data to the server, along with a local log of transmitted data.

### Step 3

The server receives the uploaded sensor data through its API, parses the incoming data for errors or inconsistencies, and stores the validated data in a central database, such as PostgreSQL. The input for this step is the structured sensor data transmitted from the terminal. The server processes this input by running data validation, normalization, and logging routines. The output is a complete, centralized record of environmental and operational state information saved for further analysis.

### Step 4

The server retrieves current and historical records from the central database and formulates a prompt sentence for a generative AI model. The input for this step is a collection of both new and historical sensor data. The server performs data preprocessing, such as feature extraction and context formatting, before embedding the relevant information in a prompt sentence. The server sends this sentence to the generative AI model and receives an analysis result as output, such as predicted optimal conditions or action recommendations.

### Step 5

The server evaluates the output from the generative AI model and generates specific control instructions for operational devices, such as irrigation pumps or delivery equipment. The input for this step is the AI-generated recommendation or prediction. The server processes this by mapping the output to actual device commands, including device selection, time scheduling, and control parameters. The output is a digital instruction encapsulated in a message for the intended device.

### Step 6

The terminal receives the digital instruction from the server, parses the message, and converts it to a hardware control signal using onboard interfaces such as GPIO or an actuator driver. The input for this step is the device command received from the server. The terminal verifies timing and device status before executing the command. The output is the actuation of hardware, such as activating irrigation or adjusting a control parameter, and logging the execution result.

### Step 7

The server prepares a user notification based on the analytics, device operations, or any detected abnormalities in the process. The input for this step includes the latest AI analysis, executed device actions, and system status. The server processes this information to generate contextual messages and sends them to the user's interactive display device, such as a mobile app or web portal. The output is the delivery and display of notifications for user awareness and interaction.

### Step 8

The user reviews notifications, inspects data logs, and optionally submits configuration changes, operational feedback, or subjective opinions via the interactive display device. The input for this step is the user's intention and interaction with the application interface. The user's actions result in new settings, feedback comments, or operational instructions, which are sent to the server for processing. The output is user-provided data or updates to system settings.

### Step 9

The server receives user inputs—such as configuration changes, feedback, or opinion information—analyzes these inputs using the generative AI model or predefined logic, and reflects necessary adjustments in system operation or notification content. The input for this step is user-submitted data. The server processes this by constructing prompt sentences or mapping commands to internal actions. The output is revised system behavior, updated notifications, or new scheduled operations reflecting user intent.

### Step 10

The server uses the emotion estimation engine to analyze user feedback, voice, or visual input to recognize the user's emotional state, such as stress or satisfaction. The input is the user's interaction data (text, voice, or image). The server processes the raw input with the emotion analysis module, derives emotion scores, and uses this emotional information to adapt notification tone, guidance level, or support content. The output is an adjusted communication style or targeted user support based on detected emotion.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In modern agriculture, optimizing plant growth conditions through effective acquisition and analysis of environmental data is essential, but manual collection and analysis require significant time and labor. Furthermore, existing systems lack the capability to flexibly adapt control of agricultural equipment according to dynamic data analysis, and rarely consider the emotional state of the user in their notifications and proposals. As a result, it is difficult to reduce user stress, provide a sense of reassurance, and achieve efficient and user-friendly automation of agricultural tasks.

The specific processing by the specific processing unit 290 of the data processing device 12 in Example 2 is realized by the following means.

The present invention provides a server including a processor configured to acquire environmental information using a physical quantity sensor, transmit and store the environmental information, perform analysis using a generative artificial intelligence model, automatically control agricultural equipment based on analysis results, notify the user of such results, analyze a user's emotional state using audio or image data, adjust notification contents and propose system setting changes in response to the emotional state, and generate prompt sentences as input for the generative artificial intelligence model. This enables efficient and accurate environmental data collection and analysis, automated agricultural equipment control, and adaptive user notification and proposal content based on user emotion, thereby supporting both agricultural productivity and user emotional well-being.

The term “physical quantity sensor” refers to a measuring device that detects and outputs information related to physical environmental parameters such as temperature, humidity, or soil moisture.

The term “environmental information” refers to data representing the physical conditions of a cultivation area, including, but not limited to, temperature, humidity, soil moisture, and other relevant parameters that influence plant growth.

The term “information processing apparatus” refers to a computing platform, such as a server, that receives, stores, analyzes, and processes environmental information.

The term “storage device” refers to a component or medium for non-volatile saving of data, such as a hard disk drive, solid-state drive, or memory.

The term “generative artificial intelligence model” refers to an artificial intelligence algorithm, typically based on machine learning, that is capable of analyzing input data and generating predictions, recommendations, or control instructions for optimization purposes.

The term “machine learning algorithm” refers to a mathematical or computational approach by which a computer system can learn patterns, correlations, or models from input data and use these to perform predictions or analyses.

The term “analysis processing” refers to a computational operation in which collected data is evaluated using algorithms, models, or artificial intelligence, to derive results such as forecasts, recommended actions, or control parameters.

The term “work device” refers to automated machinery or equipment that performs agricultural tasks, such as irrigation devices, fertilizer dispensers, or environmental control systems.

The term “control” refers to the operation or regulation of a work device through signals or commands, typically for the purpose of executing a scheduled or recommended agricultural activity.

The term “user” refers to a human operator or stakeholder who monitors, supervises, or interacts with the system.

The term “notification content” refers to message data or information that is communicated to the user, including results of analysis, operation schedules, or recommendations.

The term “audio data or image data” refers to electronic representations of the user's voice or appearance, captured by a microphone or camera, and used for the analysis of emotion.

The term “emotional state” refers to a classification of the psychological or affective condition of the user, such as being calm, stressed, or anxious, as determined by analysis of audio or image data.

The term “prompt sentence” refers to a textual input provided to the generative artificial intelligence model, describing the current data and required analysis or outcome, to guide the AI processing.

The term “user interface” refers to a means by which the user can interact with the system, input settings, confirm notifications, or provide feedback, such as an application, web portal, or display device.

A preferred embodiment of the invention will be described below to illustrate how the invention may be practically implemented. The system comprises a server including a processor, one or more terminals, a set of sensors, work devices (such as irrigation actuators or fertilizer dispensers), and a user interface device.

The user places physical quantity sensors, such as temperature sensors, humidity sensors, and soil moisture sensors, at suitable positions within a target agricultural field. These sensors may utilize well-known devices such as those based on SHT31 for temperature and humidity, or TDR-100 for soil moisture. The sensors are connected, either by wire or wirelessly (for example, using I2C, RS-485, or a wireless protocol such as LoRa), to the terminal. The terminal may be composed of general-purpose computing hardware, such as an industrial IoT gateway or an embedded single-board computer.

The terminal acquires real-time environmental information from the sensors. The terminal records the collected environmental data locally, for example, storing it in a CSV format file with timestamps. The terminal transmits the accumulated data on a scheduled basis, such as once every day, to the server using a communication protocol such as HTTPS or MQTT.

The server, which may be implemented by a general-purpose computer or a cloud computing platform, receives and stores the environmental information in a storage device, such as an SQL-based database (for example, MySQL or PostgreSQL).

The server executes analysis processing using a generative artificial intelligence model constructed with a machine learning framework, such as TensorFlow or PyTorch. The environmental information, along with analysis targets or conditions, is input to the generative AI model in the form of a prompt sentence. A typical prompt sentence may be:

“Given: temperature=25° C., humidity=60%, soil moisture=40%, and a high-temperature forecast tomorrow, generate a detailed irrigation plan for tomato crops. Output specific start times, recommended volumes, and explanation.”

The server processes the AI model output, which includes predicted optimal plant growth conditions, action recommendations (such as irrigation or fertilization schedules), and confidence levels associated with each prediction.

Based on the AI output, the server generates control commands for relevant work devices placed in the field. For example, the command to initiate irrigation at a specific time is sent from the server to the terminal, and the terminal then actuates the irrigation system, such as by activating a solenoid valve or a relay, at the exact scheduled time.

Furthermore, the server generates notification content summarizing the analysis and the scheduled operations, and transmits this content to the user interface device, which may be a smartphone application, a web application, or a dedicated display.

The server also includes an emotion analysis function. For this purpose, the user interface may capture the user's audio data or facial image data. The server analyzes this data using software libraries like OpenCV, in combination with an emotion classification API or model. If the server detects that the user is experiencing stress or anxiety, the notification content is adjusted accordingly—e.g., reassuring language is added, or additional help options are presented.

In cases where anxiety or confusion is recognized, the server proposes system configuration changes to the user, such as suggesting to enable step-by-step guidance, more frequent updates, or more detailed explanations of operations.

The server further provides a user interface through which the user may input preferences, change operational parameters, or request additional actions.

For example, for an instance where the system detects the soil moisture to be 40%, the air temperature is forecast to rise, and the user appears uncertain, the AI prompt sentence might be:

“Given the following environmental data—temperature: 25° C., humidity: 60%, soil moisture: 40%—and weather forecast for high temperature tomorrow, predict the optimal irrigation schedule for a tomato field. Output specific time recommendations and confidence in your prediction.”

This embodiment enables efficient, accurate, and adaptive agricultural operation by combining hardware sensors, generative artificial intelligence analysis, communication, emotional feedback interpretation, and user interaction, while allowing flexible adaptation to varying field, user, and environmental conditions.

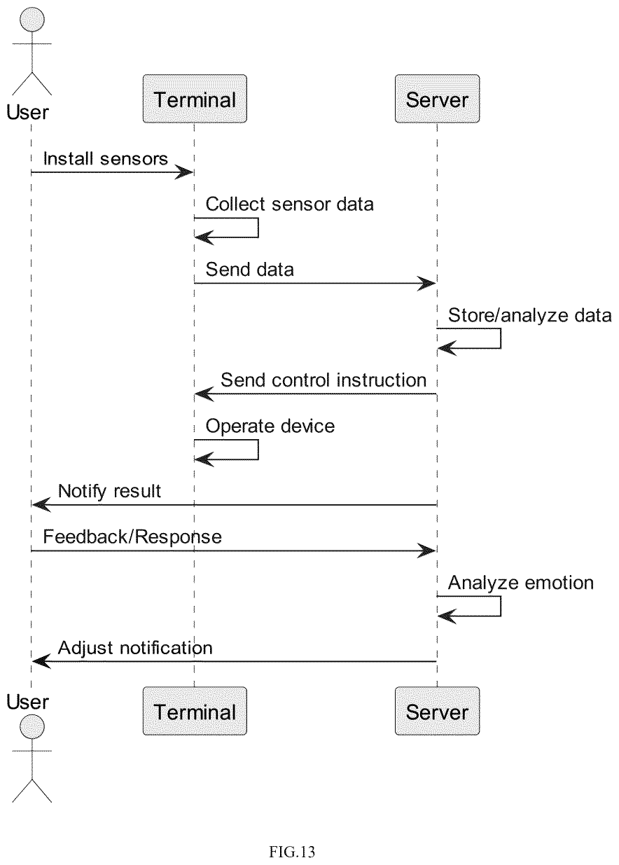

The following describes the processing flow using FIG. 13.

### Step 1

The user installs physical quantity sensors, such as temperature sensors, humidity sensors, and soil moisture sensors, in the agricultural field at appropriate locations.

Input: Location information and sensor devices.

Operation: The user selects optimum positions based on field characteristics and connects or powers on the sensors using batteries or solar panels.

Output: Activated sensors placed throughout the field and ready to collect environmental data.

### Step 2

The terminal collects real-time environmental information from the sensors, such as measured temperature, humidity, and soil moisture values.

Input: Sensor signals containing environmental parameter values.

Operation: The terminal polls each sensor at a specified interval (e.g., every 10 minutes), receives raw data streams, parses values, and validates their integrity.

Output: Acquired and validated environmental data with timestamps.

### Step 3

The terminal stores the acquired environmental data in a local storage medium, such as a CSV file with timestamped entries.

Input: Parsed environmental data (temperature, humidity, soil moisture) with timestamps.

Operation: The terminal formats the data into a tabular structure, appends it to a local file, and checks for sensor communication errors.

Output: Locally stored environmental data files (e.g., data_2024-06-20.csv).

### Step 4

The terminal transmits the accumulated environmental data to the server at a predetermined time or interval, such as every day at noon.

Input: Locally stored data files, sensor status information.

Operation: The terminal establishes a secure connection to the server and uploads the data files using HTTPS or MQTT, handling failed transmissions with retries or error logging.

Output: Successfully transferred data recorded on the server.

### Step 5

The server receives and stores the environmental information in a storage device, such as an SQL-based database.

Input: Environmental data files received from the terminal.

Operation: The server parses files, validates the data structure and accuracy, and inserts the records into the database while logging successful entries and exceptions.

Output: Structured and centralized database of environmental information.

### Step 6

The server creates a prompt sentence describing the analysis context and environmental data for processing by the generative AI model.

Input: Current and historical environmental data, analysis requirements.

Operation: The server formats a prompt sentence, such as “Given: temperature=25° C., humidity=60%, soil moisture=40%,”incorporating relevant data to guide the AI model.

Output: Prompt sentence containing context for the generative AI model.

### Step 7

The server inputs the prompt sentence and environmental information into the generative AI model for analysis.

Input: Prompt sentence and related environmental data.

Operation: The server invokes a machine learning model (e.g., TensorFlow-based), processes the input, and obtains predictions on optimal plant growth conditions or recommended actions.

Output: AI-generated predictions, recommended actions, and confidence scores.

### Step 8

The server generates control instructions for the work device based on the AI analysis output.

Input: Output of the generative AI model (recommendations, schedules, instructions).

Operation: The server translates AI recommendations into actionable device commands, such as scheduling irrigation or fertilizer application, and logs the instruction details.

Output: Structured control instruction for the terminal and work device.

### Step 9

The server transmits the generated control instruction to the terminal for execution.

Input: Control instruction prepared for a specific time, device, or operation.

Operation: The server sends the instruction using a secure protocol, awaits acknowledgment from the terminal, and records communication status.

Output: Successfully delivered device operation instruction at the terminal.

### Step 10

The terminal receives and executes the control instruction to operate the work device.

Input: Device operation instruction from the server.

Operation: The terminal schedules and triggers the device action at the designated time (e.g., opens a relay for irrigation), monitors actuator status, and triggers fail-safes if an error occurs.

Output: Successful or failed execution report of the device action.

### Step 11

The server generates notification content for the user, summarizing the AI-driven analysis results and the executed or scheduled device operations.

Input: AI analysis results, control instructions, and operation reports.

Operation: The server compiles notification messages describing recent data, operations taken, and future plans, then formats them for transmission to the user interface.

Output: Notification message prepared for user delivery.

### Step 12

The server sends the notification message to the user through a user interface, such as a smartphone application or web dashboard.

Input: Notification content generated from AI and operation reports.

Operation: The server pushes the message to the user using in-app notifications or push services, tracks message delivery, and awaits user feedback.

Output: Notification received and displayed on the user device.

### Step 13

The user has the option to respond through the user interface, such as confirming receipt, requesting details, or changing preferences.

Input: Notification content and available user interface options.

Operation: The user interacts with the application to confirm, provide feedback, or adjust system settings as desired.

Output: User input data sent to the server.

### Step 14

The server analyzes audio or image data from the user to determine the user's emotional state.

Input: User-provided voice data, facial images, or video data through the user interface.

Operation: The server uses an emotion recognition model (e.g., OpenCV with emotion classification API), classifies the emotional state (calm, stressed, anxious), and assigns a confidence score.

Output: Emotional state classification sent to the notification adjustment process.

### Step 15

The server adjusts the notification content and/or proposes customized system setting changes based on the user's emotional state.

Input: Classified emotional state of the user.

Operation: The server modifies notification content for reassurance if stress or anxiety is detected, and, if appropriate, sends proposals to enable guidance or more frequent updates.

Output: Emotion-adaptive notification and setting proposals delivered to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In the field of automation and optimization of agriculture, it has been difficult to achieve real-time collection and analysis of environmental information, as well as autonomous control of agricultural equipment based on analytical results. Furthermore, conventional systems do not recognize the emotional state of users or adapt notification content accordingly to improve the user experience. There is a demand for a comprehensive system capable of providing real-time environmental monitoring, AI-based analysis, automatic equipment control, and user feedback adapted to user emotions.

The specific processing by the specific processing unit 290 of the data processing device 12 in Application Example 2 is realized by the following means.

The present invention provides a server including an information processing apparatus configured to acquire environmental information from an information acquisition device, analyze the information using a generative artificial intelligence model, generate control commands for autonomous operation of equipment, notify users of relevant results and control commands via a user interface, analyze user emotion using an emotion recognition program based on audio or visual user input, and adapt notification content accordingly. This enables real-time environmental data analysis and autonomous equipment operation as well as adaptive and responsive user interaction that considers user emotional states, thereby improving agricultural efficiency and user satisfaction.

The term “environmental information” refers to data obtained from the surroundings of a target area, including but not limited to temperature, humidity, soil moisture, and other physical and chemical parameters relevant to agricultural activities.

The term “information acquisition apparatus” refers to a general-purpose or dedicated device capable of collecting environmental information from a designated area, including but not limited to various types of sensors and measurement devices.

The term “information processing apparatus” refers to a computational unit or server configured to receive, store, analyze, and process data, and to execute algorithms and instructions required for system operation.

The term “storage apparatus” refers to any memory device, database, or storage medium capable of storing digital data in an accessible and retrievable format.

The term “generative artificial intelligence model” refers to a computational model employing machine learning or neural network techniques that is configured to generate predictive or analytical results based on input data.

The term “control command” refers to an instruction or set of instructions generated by the system for the purpose of automatically controlling the operation of an apparatus, device, or equipment.

The term “autonomous mobile apparatus” refers to a mobile device or vehicle capable of performing tasks or navigation without direct human intervention, especially in an agricultural context.

The term “work control apparatus” refers to a device or component responsible for performing specific agricultural or environmental management operations according to received control commands.

The term “user interface” refers to hardware and/or software components enabling interaction and information exchange between the user and the system, such as graphical displays, application screens, or input devices.

The term “emotion recognition program” refers to a software module that analyzes user input such as voice or facial image data in order to determine the emotional state of the user.

The term “setting change” refers to any modification or adjustment of system parameters, schedules, or operation preferences performed by the user.

The term “additional instruction” refers to any supplementary command or input provided by the user that directs the system to perform a specific operation or task beyond previously established routines or settings.

One embodiment for implementing the invention will now be described in detail. The system comprises an information processing apparatus (server), an information acquisition apparatus (terminal equipped with various sensors), a storage apparatus, autonomous mobile equipment or a work control apparatus, a user interface, and software modules including a generative AI model and an emotion recognition program.

The terminal operates as an information acquisition apparatus. The terminal contains sensors such as temperature sensors, humidity sensors, and soil moisture sensors. These sensors collect environmental information in real time from a given agricultural field or environment. The terminal includes local storage, for example, a built-in SSD or flash memory, used to temporarily save the measured sensor data. The terminal is equipped with a communication module, such as a general wireless module (Wi-Fi or LTE), to transfer the environmental information to the server at scheduled intervals.

The server functions as an information processing apparatus and is connected to a storage apparatus such as a general-purpose database server (for example, PostgreSQL). The server receives environmental information sent from the terminal, stores the data in the database, and processes it with a generative artificial intelligence model. Examples of suitable AI frameworks include TensorFlow and PyTorch, on which the generative AI model may be implemented. The server generates a prompt sentence that summarizes the new sensor data as input to the AI model. The model analyzes the data to predict or recommend optimal agricultural actions, such as scheduling irrigation or fertilization.

As a specific example, the terminal records temperature and humidity values at 10:00 AM, such as “25° C.” and “60% humidity,” and stores this data locally. At noon, the terminal uploads the collected data to the server. The server then uses the following prompt sentence for the generative AI model:

“Analyze tomorrow's predicted temperature and humidity, and determine if watering is needed at 2:00 PM. If the user is experiencing stress, send a gentle notification message.”

The AI model outputs a prediction such as: “Watering is recommended at 2:00 PM for 10 minutes.”

Based on the analytical result, the server converts the AI model's recommendation into a control command. The control command is transmitted to the terminal, which forwards the instruction to the relevant autonomous mobile equipment or work control apparatus. For example, the terminal may control a valve actuator on an irrigation system based on the received command, such that the irrigation automatically starts at 2:00 PM and stops 10 minutes later.

The server also serves as a notification center. It sends reports containing analysis results and future control schedules to the user via a user interface. The user interface is realized as a mobile application built using React Native or Flutter, providing real-time access to system status and notifications. The user can interact with and configure the system through the user interface, for instance, by changing irrigation times or other control preferences.

In addition, the user may provide voice or image data (for example, by recording audio messages or using the smartphone's camera) via the user interface. This data is transmitted to the server, where an emotion recognition program analyzes the user's emotional state. For emotion analysis, widely used software such as a general-purpose natural language and emotion analytics engine can be utilized. Upon detecting signs of stress or worry, the server adjusts the notification messages to provide encouragement or reassurance, such as changing the message to:

“You do not need to worry; everything is managed automatically and efficiently.”

Furthermore, the user can perform setting changes and issue additional instructions through the app. The server takes such user inputs into account in subsequent analyses and control command generations.

Through the integration of a generative AI model and an emotion recognition program, in combination with user interfaces, general-purpose sensors, and standard computing platforms (such as servers and cloud databases), the embodiment enables robust, efficient, and adaptive agricultural automation and user interaction.

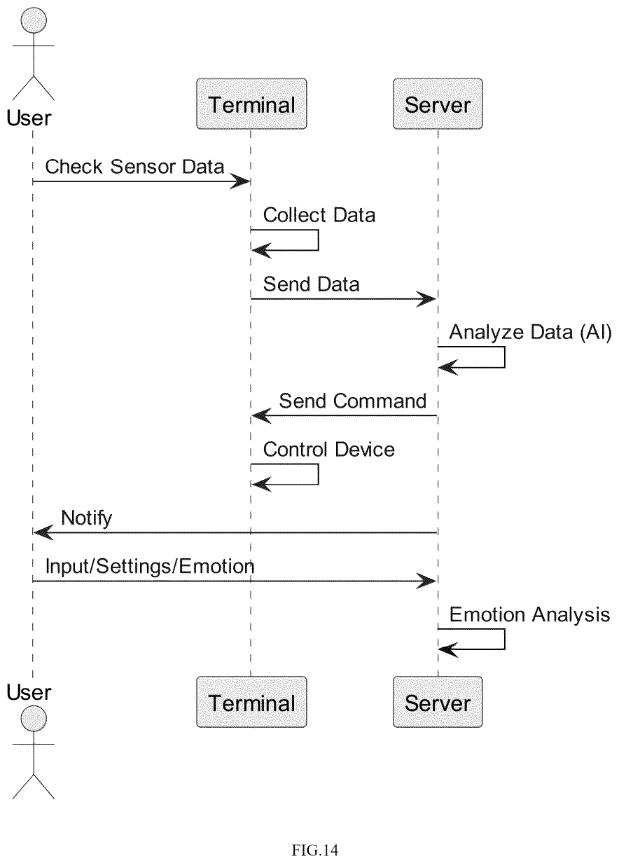

The following describes the processing flow using FIG. 14.

### Step 1

The terminal acquires environmental information using various sensors, such as temperature, humidity, and soil moisture sensors. The input for this step consists of real-world environmental conditions, which the sensors convert into digital data. The terminal stores each measurement in its local storage with a timestamp. The output of this step is a record of environmental information (e.g., “10:00 AM, temperature 25° C., humidity 60%”) saved in the terminal's memory.

### Step 2

The terminal periodically uploads the recorded environmental information to the server via a wireless communication module. The input is the stored sensor data collected in Step 1. As the terminal prepares a data packet and sends it to the server, data transmission protocols ensure reliable delivery. The output is successful transfer of environmental information from the terminal to the server.

### Step 3

The server receives the environmental information from the terminal and writes it to a storage apparatus, such as a database. The input for this step is the sensor data packet received over the network. The server parses, validates, and structures the data before saving it in the database. The output is the stored environmental data, now ready for further analysis.

### Step 4

The server constructs a prompt sentence summarizing the received environmental information, and then applies a generative AI model implemented with, for example, TensorFlow or PyTorch. The input includes the stored environmental data and the prompt sentence. The server processes this data through the AI model, which analyzes environmental trends and predicts optimal agricultural actions. The output is an analytical result or recommendation, such as “Activate irrigation at 2:00 PM for 10 minutes.”

### Step 5

The server translates the AI's analytical result into a control command and transmits it to the terminal. The input is the recommendation generated by the generative AI model in Step 4. The server formats the recommendation as a standardized control command and sends it digitally to the terminal. The output is the transmission of the control command to the relevant terminal.

### Step 6

The terminal receives the control command from the server and schedules the corresponding operation on the autonomous mobile equipment or work control apparatus. The input is the control command, such as “Start irrigation at 2:00 PM.” The terminal, using its internal timer and I/O control software, initiates device operations, such as opening or closing a valve, precisely at the commanded time. The output is the actual execution of the agricultural task (e.g., irrigation started for 10 minutes).

### Step 7

The server prepares a notification containing the analysis result and control information, then sends it to the user's mobile app through the user interface. The input is the analysis result and details of executed or scheduled control commands. The server uses a notification service (such as push alerts) to deliver this information. The output is a real-time alert displayed on the user's device, such as “High temperature is expected tomorrow. Irrigation will start at 2:00 PM for 10 minutes.”

### Step 8

The user, upon receiving the notification, may respond by interacting with the user interface, for example by submitting a voice message or photo via the app. The input for this step is the user's interaction and corresponding data (audio or image file). The app transmits the user's data to the server. The output is user-generated data available for emotion analysis.

### Step 9

The server processes user-provided voice or image data using an emotion recognition program. The input is the audio or image file received from the user. The server analyzes the emotional features of the input and detects the user's emotional state, such as stress or concern. Based on the detected emotion, the server modifies future notification content to be more supportive or reassuring. The output is an adapted notification strategy designed to improve user experience.

### Step 10

The user can issue setting changes or additional instructions, such as modifying irrigation schedules, through the user interface. The input is the user's command or adjustment submitted via the app. The server receives, validates, and stores these changes, adjusting subsequent data processing and control logic as needed. The output is an updated configuration and system behavior that reflects the user's preferences.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

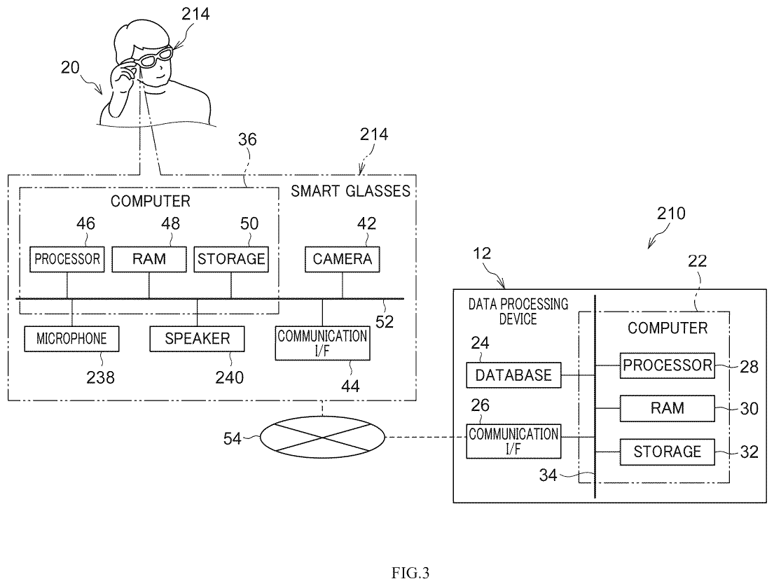

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

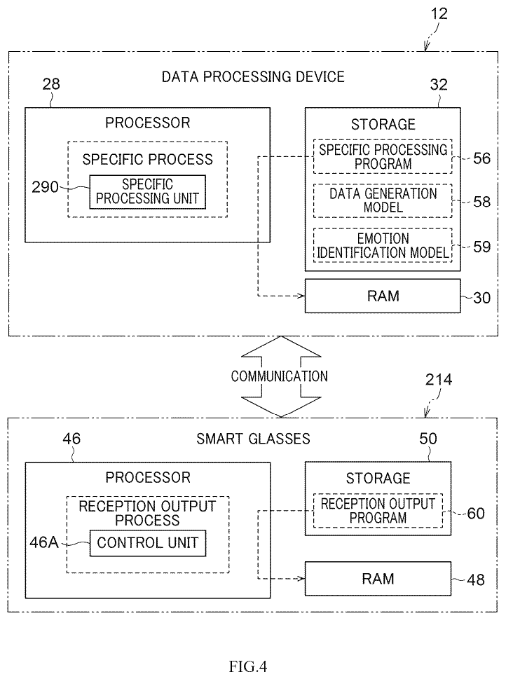

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

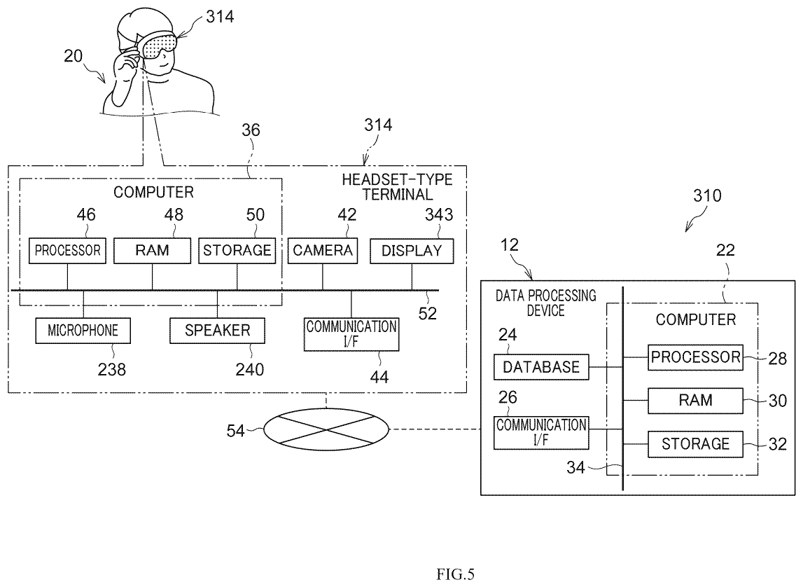

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

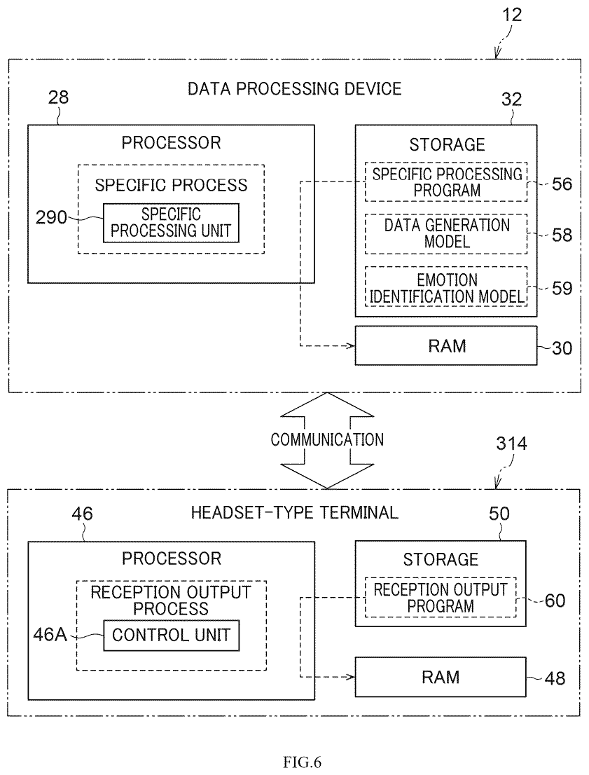

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

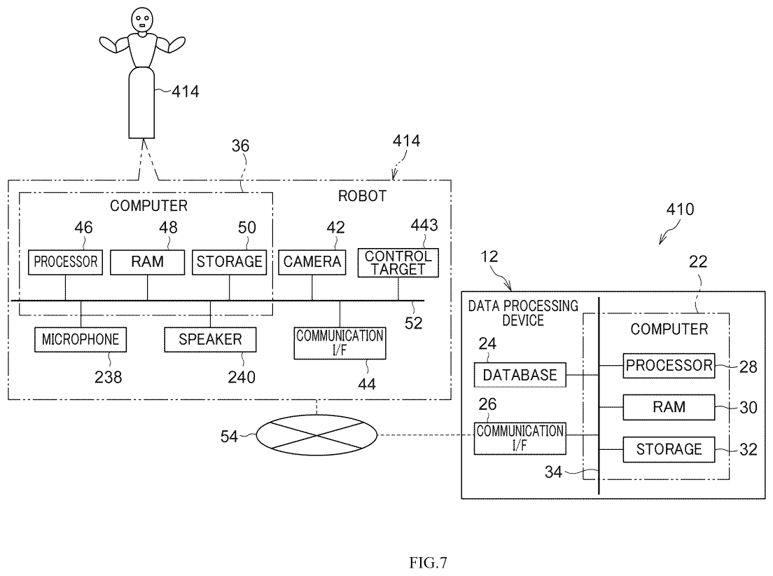

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

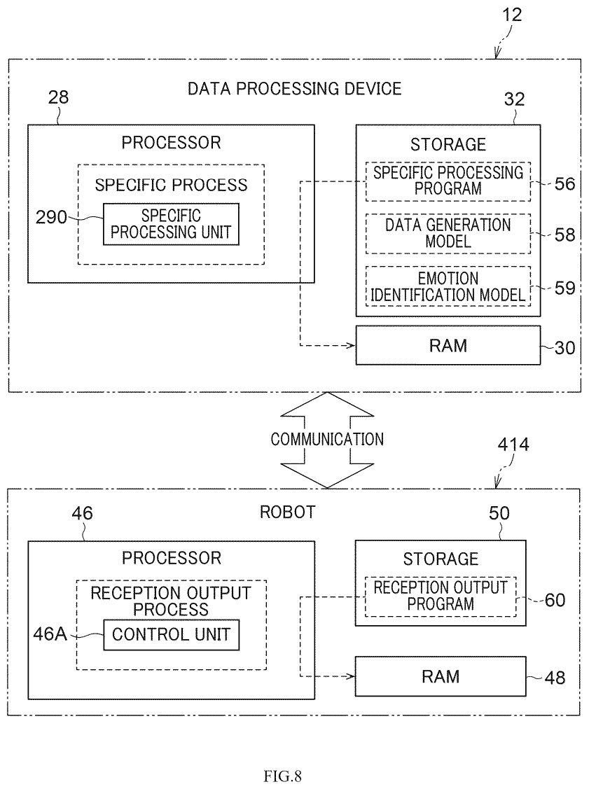

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

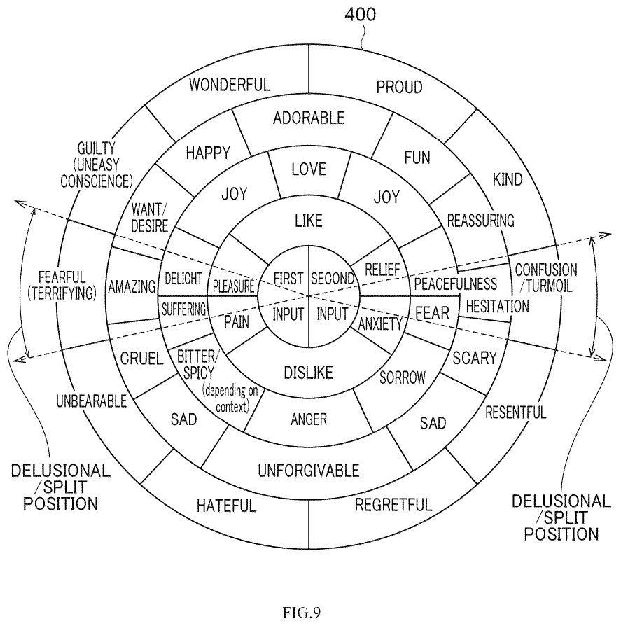

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more”and “want to know more”is experienced.

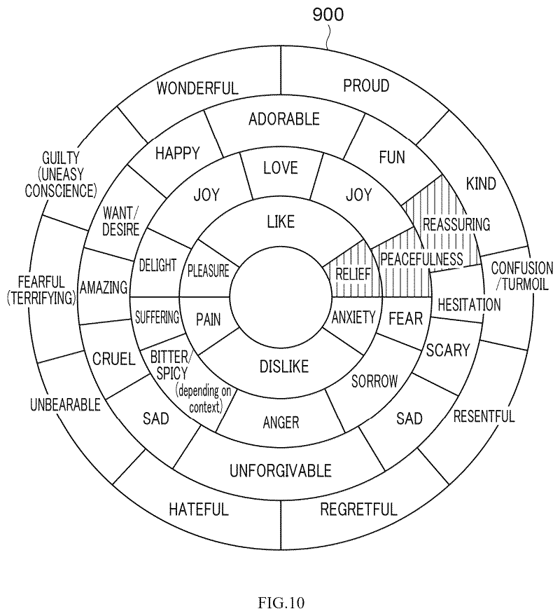

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system including a processor,
wherein the processor is configured to
acquire environmental state information using an information acquisition device,
temporarily store the environmental state information in a terminal device and transmit the environmental state information to an information processing device at predetermined intervals,
store the environmental state information in an information storage apparatus within the information processing device,
execute an analysis process by using a generative artificial intelligence model, analyze the environmental state information stored in the information storage apparatus, and, in the course of the analysis process, generate an input sentence for the generative artificial intelligence model to improve analysis accuracy,
generate control instructions for a work machinery control device automatically based on the analysis process results, and output the control instructions to the terminal device,
cause the terminal device to receive the control instructions and operate a work machinery, and
notify a user terminal of the analysis process results and control instruction information.

### Supplementary 2

The system according to supplementary 1,
wherein the processor is configured to predict optimal breeding conditions for organisms based on the environmental state information and accumulated historical information by the generative artificial intelligence model, and to dynamically generate an input sentence for analysis in accordance with the intended use.

### Supplementary 3

The system according to supplementary 1,
wherein the processor is configured to update the control instruction content or analysis setting based on information received from a user input via a dedicated operation interface.

### Application Example 1

### Supplementary 1

A system including a processor,
wherein the processor is configured to
obtain state information using an information acquisition device,
transmit the state information to an information processing device,
store the state information together with historical records in the information processing device,
analyze the state information and the stored historical records using a generative artificial intelligence model,
automatically control an operation device based on a result of the analysis,
notify a user of the analysis result and control content via an interactive display device,
receive operation inputs or opinion information from the user,
analyze the operation inputs or opinion information using the generative artificial intelligence model and reflect an analysis result in at least one of notification content or control operations,
obtain operation status and environmental status of multiple moving objects and automatically generate route selection instructions, and
adjust the notification content or auxiliary operations by recognizing the emotional state of the user using an emotion estimation engine.

### Supplementary 2

The system according to supplementary 1,
wherein the processor is configured to estimate optimal operation conditions based on the state information and the historical records using the generative artificial intelligence model.

### Supplementary 3

The system according to supplementary 1,
wherein the processor is configured to accept operation inputs or opinion information via the interactive display device, and automatically analyze and reflect the input or opinion in control operations or notifications.

### Example 2

### Supplementary 1

A system including a processor,
wherein the processor is configured to
acquire environmental information using a physical quantity sensor,
transmit the environmental information to an information processing apparatus,
store the environmental information in a storage device,
perform analysis processing by inputting the stored environmental information to a generative artificial intelligence model using a machine learning algorithm,
execute control of a work device automatically based on a result of the analysis processing,
notify a user of the result of the analysis processing and control information,
analyze audio data or image data of the user to identify an emotional state,
adjust a notification content in accordance with the identified emotional state,
propose a system configuration change to the user based on the identified emotional state, and
generate a prompt sentence to be inputted to the generative artificial intelligence model together with the environmental information and analysis condition.

### Supplementary 2

The system according to supplementary 1,
wherein the processor is configured to
cause the generative artificial intelligence model to execute an optimization estimation algorithm for plant growth condition.

### Supplementary 3

The system according to supplementary 1,
wherein the processor is configured to
provide a user interface that allows the user to change system configuration or input additional instructions.

### Application Example 2

### Supplementary 1

A system including a processor,
wherein the processor is configured to
acquire environmental information using an information acquisition apparatus,
transmit the acquired environmental information to an information processing apparatus,
store the received environmental information in a storage apparatus and analyze the stored environmental information using a generative artificial intelligence model to generate a control command based on the analysis result,
transmit the generated control command to an autonomous mobile apparatus or a work control apparatus to automatically control the operation of said apparatus,
notify a user of the analysis result and the control command via a user interface,
obtain voice information or image information as user input, analyze a user's emotional state by an emotion recognition program, and adjust notification content based on the result of said analysis, and
accept input for setting changes or additional instructions from the user.

### Supplementary 2

The system according to supplementary 1,
wherein the processor is configured to perform predictive analysis for a cultivation target by the generative artificial intelligence model and derive optimal environmental conditions for cultivation.

### Supplementary 3

The system according to supplementary 1,
wherein the processor is configured to adaptively change the notification content based on the result of the emotion recognition program.

What is claimed is:

1. A system comprising a processor,
wherein the processor is configured to
collect environmental data using a sensor,
transmit the environmental data to a server,
analyze the environmental data using a generative AI,
automatically control agricultural equipment based on the data analysis, and
notify a user of the analysis results and control information.

2. The system according to claim 1,
wherein the processor includes an algorithm by which the generative AI predicts optimal growth conditions for plants.

3. The system according to claim 1,
wherein the processor includes an interface that allows the user to make setting changes or additional instructions to the system.
